(19) United States
(12) Patent Application Publication
(10) Pub. No.: US 2024/0349693 A1
(43) Pub. Date: Oct. 24, 2024

(54) FOLDABLE APPARATUS FOR FEEDING PETS

(71) Applicants: Bryan Doom, Duluth, GA (US); Senora Doom, Duluth, GA (US)

(72) Inventors: Bryan Doom, Duluth, GA (US); Senora Doom, Duluth, GA (US)

(21) Appl. No.: 18/138,638

(22) Filed: Apr. 24, 2023

(51) Int. Cl. A01K 5/01

(52) U.S. Cl. CPC A01K 5/0107

(57) ABSTRACT

A foldable apparatus for feeding pets is disclosed. The apparatus comprises a vertical base module mounted on a vertical surface, and a horizontal container module having an opening for receiving a container. The horizontal container module is pivotably connected to a lower section of the vertical base module, allowing it to fold upwards and into the vertical base module in a closed configuration, thereby saving space when not in use. In an open configuration, the horizontal container module rests at an angle perpendicular to the vertical base module, providing a stable and comfortable feeding position for pets. The foldable apparatus can be customized for various container sizes and types, and can be installed at different heights to accommodate the size and mobility needs of pets. The invention offers numerous advantages, including space-saving design, adaptability, easy cleaning and maintenance, aesthetically pleasing appearance, enhanced feeding experience, improved pet health, and enhanced safety.

### TECHNICAL FIELD

The present invention relates generally to pet accessories, and more particularly, to a foldable apparatus for feeding pets, such as dogs, cats, and the like.

### BACKGROUND

Pet owners are constantly looking for ways to enhance the feeding experience of their pets while keeping their living spaces organized and clean. Traditional pet feeding devices, such as bowls or feeding stations, can occupy significant floor space, be obtrusive, and require regular cleaning. Additionally, traditional pet feeding devices may not be suitable for pets with mobility issues or for those who prefer a more elevated feeding position.

Various devices have been developed to address some of these concerns. However, these devices may not be convenient, practical, or attractive for use in all environments. Therefore, there is a need for a foldable pet feeding apparatus that saves space, is adaptable to various living spaces, and provides an improved feeding experience for pets.

### SUMMARY OF THE INVENTION

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

The present invention provides a foldable apparatus for feeding pets, such as dogs, cats, and the like. The apparatus comprises a vertical base module mounted on a vertical surface, and a horizontal container module having an opening for receiving a container. The horizontal container module is pivotably connected to a lower section of the vertical base module. The horizontal container module folds upwards and into the vertical base module in a closed configuration.

In another embodiment, the horizontal container module rests in an angle perpendicular to the vertical base module in an open configuration.

In yet another embodiment, the vertical surface comprises a wall or a door.

In a further embodiment, the container is a collapsible container.

In another embodiment, the collapsible container extends outwards or retracts into the vertical base module.

In yet another embodiment, the container is removable.

In a further embodiment, the container rests upon an annular ring provided on the opening of the horizontal container module.

In another embodiment, the vertical base module is fixed to the vertical surface using a plurality of fasteners.

In yet another embodiment, the vertical base module comprises a locking pin for securely holding the horizontal container module within the vertical base module when the foldable apparatus is in a closed configuration.

In a further embodiment, the horizontal container module comprises a locking slot for containing the locking pin of the vertical base module.

This summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

The detailed description provides a better understanding of the foldable apparatus for feeding pets, such as dogs, with reference to the accompanying figures. While the invention is described with reference to specific embodiments, it should be understood that these embodiments are provided for illustrative purposes only and are not intended to limit the scope of the invention.

FIG. 1 is an exemplary perspective view 100 of the foldable apparatus for feeding pets in an open configuration according to the embodiments of the present disclosure.

FIG. 2 is another exemplary perspective view 200 of the foldable apparatus for feeding pets in an open configuration according to the embodiments of the present disclosure.

FIG. 3 is a rear view 300 of the horizontal container module with a collapsible container in a retracted configuration according to the embodiments of the present disclosure.

FIG. 4 is a rear view 400 of the horizontal container module with a collapsible container in an extended configuration according to the embodiments of the present disclosure.

FIG. 5 is a perspective view 500 of the foldable apparatus in a closed configuration according to the embodiments of the present disclosure.

FIG. 6 is an exemplary illustration 600 of the vertical base module of the foldable apparatus according to the embodiments of the present disclosure.

FIG. 7 is an exemplary illustration 700 of the horizontal container module without a container according to the embodiments of the present disclosure.

### DETAILED DESCRIPTION

The detailed description refers to the accompanying figures and provides a comprehensive understanding of the foldable apparatus for feeding pets, such as dogs. The invention is described with reference to specific embodiments, but these embodiments are provided for illustrative purposes only and are not intended to limit the scope of the invention.

In the following description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limited sense, and the scope of the present invention is defined only by the appended claims.

The specification may refer to “an”, “one” or “some” embodiment(s) in several locations. This does not necessarily imply that each such reference is to the same embodiment(s), or that the feature only applies to a single embodiment. A single feature of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the foregoing sections, some features are grouped together in a single embodiment for streamlining the disclosure. This method of disclosure is not to be interpreted as reflecting an intention that the disclosed embodiments of the present disclosure must use more features than are expressly recited in each claim. Rather, as the following claims reflect, the inventive subject matter lies in less than all features of a single disclosed embodiment. Thus, the following claims are hereby incorporated into the detailed description, with each claim standing on its own as a separate embodiment.

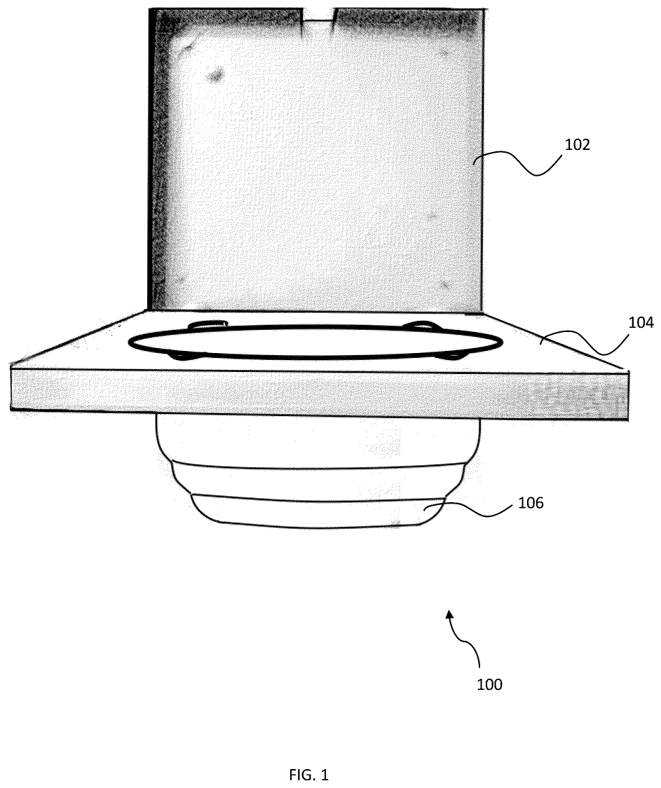

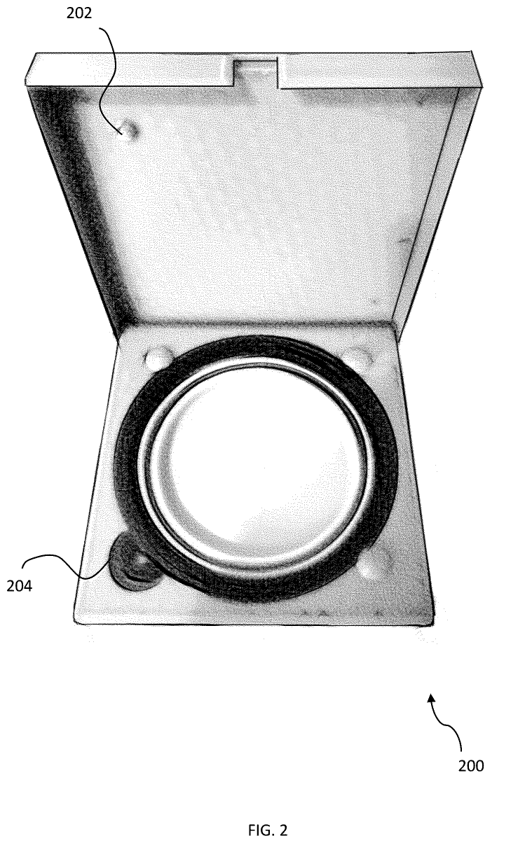

Referring now to FIGS. 1 and 2, the foldable apparatus for feeding pets, according to an embodiment of the present disclosure, comprises a vertical base module 102 and a horizontal container module 104. The vertical base module is mounted on a vertical surface, such as a wall or a door. The horizontal container module 104 is pivotably connected to the lower section of the vertical base module 102 and has an opening for receiving a container 106.

In the open configuration, as shown in FIGS. 1 and 2, the horizontal container module 104 rests at an angle perpendicular to the vertical base module 102. This configuration allows a pet to easily access the container for feeding. The container 106 may be a bowl, dish, or any other suitable receptacle for holding pet food or water.

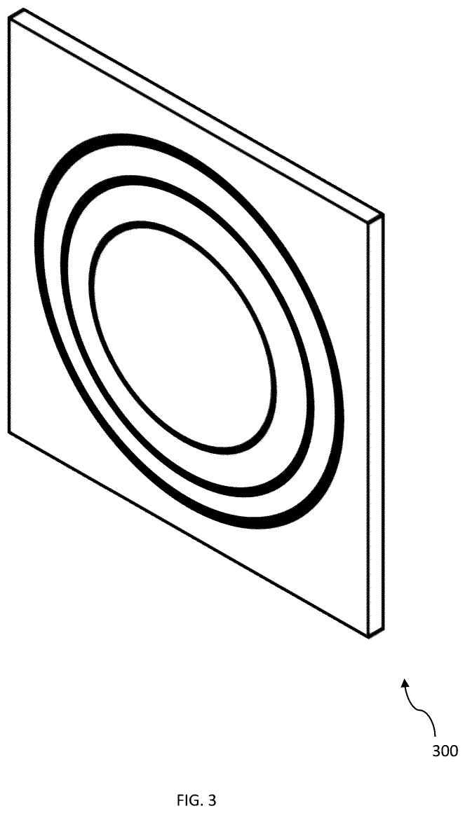

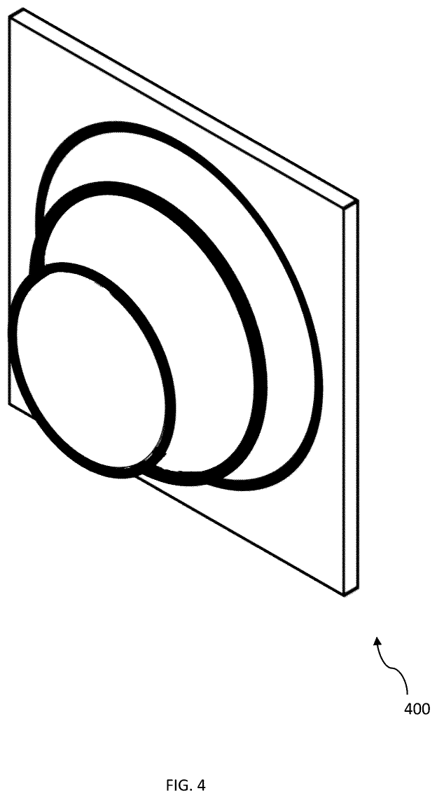

In one embodiment, the container 106 is a collapsible container, as shown in FIGS. 3 and 4. The collapsible container may be made of a flexible material, such as silicone, which allows the container to extend outwards (FIG. 4) for use or retract into the vertical base module 102 (FIG. 3) when not in use.

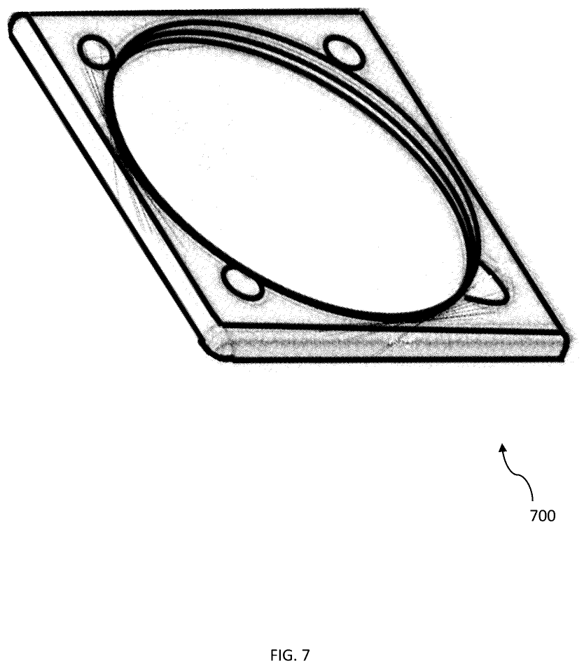

In another embodiment, the container 106 is removable from the horizontal container module 104, as shown in FIG. 7. This feature allows for easy cleaning and replacement of the container 106. The container 106 may rest upon an annular ring provided on the opening of the horizontal container module 104 to ensure stability during feeding.

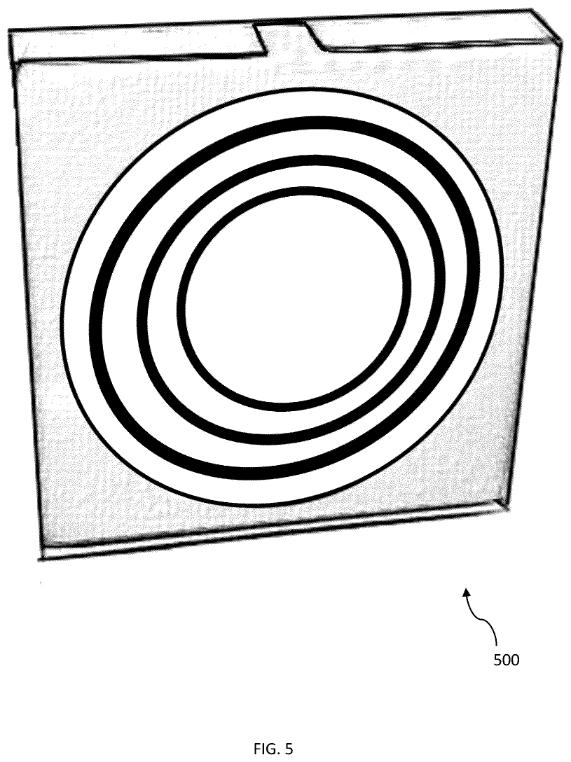

The vertical base module 102 may be fixed to the vertical surface using a plurality of fasteners, such as screws, nails, or adhesive strips. In one embodiment, the vertical base module 102 comprises a locking pin 202 for securely holding the horizontal container module 104 within the vertical base module 102 when the foldable apparatus is in a closed configuration, as shown in FIG. 5. The horizontal container module may comprise a locking slot 204 for containing the locking pin 202 of the vertical base module 102.

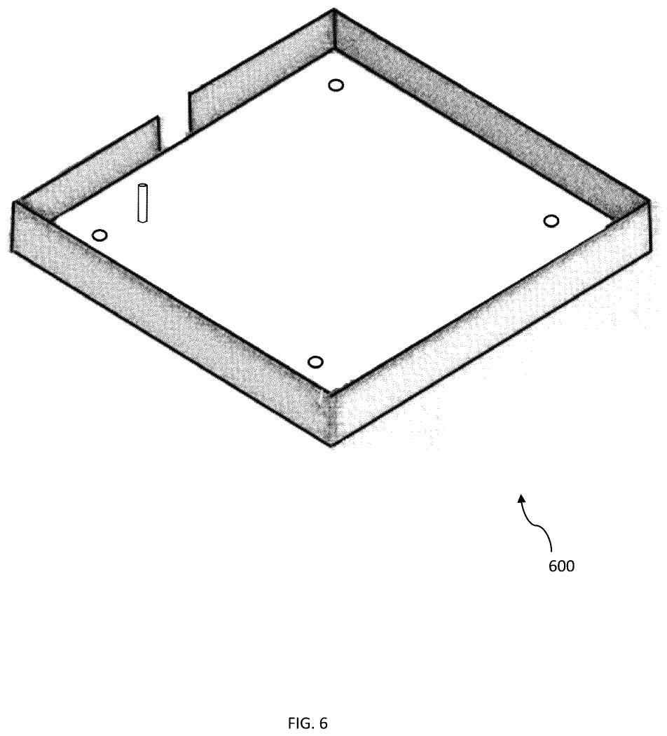

FIG. 6 illustrates an exemplary embodiment of the vertical base module 102 of the foldable apparatus. The vertical base module 102 may be made of a rigid material, such as wood, plastic, or metal, and may be designed in various shapes, sizes, and colors to match the decor and aesthetics of various living spaces. The vertical base module 102 may also comprise a plurality of mounting holes for receiving the fasteners to secure the foldable apparatus to the vertical surface.

In operation, the foldable apparatus may be installed at a desired height on a vertical surface, such as a wall or a door, to accommodate the size and mobility needs of the pet. The horizontal container module 104 can be unfolded from the vertical base module 102 to an open configuration for feeding, with the container in place. The pet can then access the container for feeding or drinking. After the pet has finished feeding, the horizontal container module 104 can be folded back into the vertical base module 102, resulting in a closed configuration that minimizes the footprint of the apparatus and maintains a clean and organized living space.

In conclusion, the foldable apparatus for feeding pets provides a practical, space-saving, and aesthetically pleasing solution that caters to the diverse needs and preferences of pet owners. The various embodiments of the invention allow for customization and adaptability, making the foldable apparatus a valuable addition to any pet-friendly home. The foldable apparatus not only enhances the feeding experience for pets but also promotes a clean, organized, and visually appealing environment for pet owners.

The foldable apparatus for feeding pets described herein offers numerous advantages over traditional pet feeding devices. Some of the key advantages include:

Space-saving design: The foldable apparatus saves space by folding upwards and into the vertical base module when not in use, thereby minimizing its footprint in the living space. This is particularly beneficial for pet owners with limited living spaces or for those who desire a clutter-free environment.

Adaptability: The foldable apparatus can be mounted at different heights on a vertical surface to accommodate the size and mobility needs of various pets. This feature is beneficial for pets with mobility issues, such as arthritis, or for those who prefer a more elevated feeding position.

Easy to clean and maintain: The removable container feature allows for easy cleaning and replacement of the container, ensuring a hygienic feeding environment for the pets. Additionally, the collapsible container can be easily cleaned and stored when not in use.

Aesthetically pleasing: The foldable apparatus can be designed in various shapes, sizes, and colours to match the decor and aesthetics of various living spaces. This allows pet owners to maintain a visually appealing environment while providing an improved feeding experience for their pets.

Travel-friendly: The use of a collapsible container allows for easy storage and transport of the foldable apparatus, making it ideal for pet owners who travel or have limited living spaces.

Enhanced feeding experience: The foldable apparatus provides an improved feeding experience for pets by offering a stable and comfortable feeding position. The design of the horizontal container module ensures that the container remains steady during feeding, minimizing the risk of spills and messes on the floor.

Improved pet health: By allowing pet owners to adjust the height of the foldable apparatus, pets can feed in a more ergonomic position that reduces strain on their neck, back, and joints. This can lead to improved digestion, reduced risk of choking, and overall better health for the pets.

Customizable: The foldable apparatus can be tailored to accommodate various container sizes and types, allowing pet owners to choose the most appropriate container for their pet's specific needs. This customization can help address the specific dietary requirements and preferences of individual pets.

Easy installation: The foldable apparatus can be easily installed on a variety of vertical surfaces, such as walls and doors, using a plurality of fasteners. This versatility makes it suitable for use in different environments and living spaces.

Enhanced safety: The locking pin and locking slot features ensure that the horizontal container module is securely held within the vertical base module when the foldable apparatus is in a closed configuration. This prevents accidental unfolding of the apparatus and ensures the safety of both pets and their owners.

In summary, the foldable apparatus for feeding pets provides a practical, space-saving, and aesthetically pleasing solution for pet owners who seek to enhance the feeding experience of their pets while maintaining a clean and organized living space. The various embodiments and features of the invention cater to the diverse needs and preferences of pet owners, ensuring that the foldable apparatus is a valuable addition to any pet-friendly home.

The above-described exemplary embodiments of the present invention are for the purpose of illustration only. Although the invention has been described in conjunction with specific embodiments thereof, numerous modifications may be made without materially departing from the teachings and advantages of the subject matter described herein. Other substitutions, modifications, and changes may be made without departing from the spirit of the present invention. All the features disclosed in this specification (including any accompanying drawings) and/or all of the steps of any method or process so disclosed may be combined in any combination, except combinations where at least some of such features and/or steps are mutually exclusive.

The terms “include,” “have,” and variations thereof, as used herein, have the same meaning as the term “comprise” or an appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All the features disclosed in this specification (including any accompanying claims, abstract, and drawings), and all of the steps of any method or process so disclosed, may be combined in any combination, except combinations where at least some of such features or steps are mutually exclusive.

The terms “include,” “have,” and variations thereof, as used herein, have the same meaning as the term “comprise” or an appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A foldable apparatus for feeding pets, comprising:
a vertical base module mounted on a vertical surface; and
a horizontal container module having an opening for receiving a container, wherein the horizontal container module pivotably connected to a lower section of the vertical base module, and wherein the horizontal container module folds upwards and into the vertical base module in a closed configuration.

2. The foldable apparatus of claim 1, wherein the horizontal container module rests in an angle perpendicular to the vertical base module in an open configuration.

3. The foldable apparatus of claim 1, wherein the vertical surface comprises of a wall or a door.

4. The foldable apparatus of claim 1, wherein container is a collapsible container.

5. The foldable apparatus of claim 4, wherein the collapsible container extends outwards or retracts into the vertical base module.

6. The foldable apparatus of claim 1, wherein the container is removable.

7. The foldable apparatus of claim 1, wherein the container rests upon an annular ring provided on the opening of the horizontal container module.

8. The foldable apparatus of claim 1, wherein the vertical base module is fixed to the vertical surface using a plurality of fasteners.

9. The foldable apparatus of claim 1, wherein the vertical base module comprises a locking pin for securely holding the horizontal container module within the vertical base module when the foldable apparatus is in a closed configuration.

10. The foldable apparatus of claim 9, wherein the horizontal container module comprises of a locking slot for containing the locking pin of the vertical base module.
